(19) United States
(12) Patent Application Publication
(10) Pub. No.: US 2020/0167641 A1
(43) Pub. Date: May 28, 2020

(54) CONTRASTIVE EXPLANATIONS FOR INTERPRETING DEEP NEURAL NETWORKS

(71) Applicant: International Business Machines Corporation, Armonk, NY (US)

(72) Inventors: Amit Dhurandhar, Yorktown Heights, NY (US); Pin-Yu Chen, Yorktown Heights, NY (US); Ronny Luss, Yorktown Heights, NY (US); Karthikeyan Shanmugam, Yorktown Heights, NY (US); Payel Das, Yorktown Heights, NY (US)

(21) Appl. No.: 16/202,249

(22) Filed: Nov. 28, 2018

(51) Int. Cl. G06N 3/08; G06N 7/00

(52) U.S. Cl. CPC G06N 3/08; G06N 7/005

(57) ABSTRACT

A method, system, and computer program product, including highlighting a minimally sufficient component in an input to justify a classification, identifying contrastive characteristics or features that are minimally and critically absent, maintaining the classification and distinguishing it from a second input that is closest to the classification but is identified as a second classification.

### BACKGROUND

The present invention relates generally to a contrastive explanation method, and more particularly, but not by way of limitation, to a system, method, and recording medium for providing contrastive explanations justifying the classification of an input by a black box classifier such as a deep neural network.

Explanations as such are used frequently by people to identify other people or items of interest. This is seen in this cases that characteristics such as being tall and having long hair help describe the person, although incompletely. The absence of glasses is important to complete the identification and help distinguish him from, for instance, “Bob who is tall, has long hair and wears glasses”. It is common for us humans to state such contrastive facts when one wants to accurately explain something. These contrastive facts are by no means a list of all possible characteristics that should be absent in an input to distinguish it from all other classes that it does not belong to, but rather a minimal set of characteristics/features that help distinguish it from the “closest” class that it does not belong to.

Conventionally researchers have put great efforts in devising algorithms for interpretable modeling. Examples include establishment for rule/decision lists, prototype exploration, developing methods inspired by psychometrics, and learning human-consumable models.

Other conventional techniques attempt to find sufficient conditions to justify classification decisions. As such, these techniques attempt to find feature values whose presence conclusively implies a class. Hence, these are global rules (called ‘anchors’) that are sufficient in predicting a class. They are customized for each input. Moreover, a dataset may not always possess such anchors, although one can almost always find them.

However, the conventional techniques have several technical problems. Firstly, the (untargeted) attack techniques are largely unconstrained where additions and deletions are performed simultaneously, thereby resulting in a need for a case for a pertinent positive (PP) and a pertinent negative (PN) to only allow deletions and additions respectively. Secondly, the optimization objective for PPs is itself not distinct and does not search for features that are minimally sufficient in themselves to maintain the original classification.

As such, there is a need in the art for attack methods that can be adapted to create effective explanation methods.

### SUMMARY

In view of the technical problems in the art, the inventors have invented a technical improvement to address the technical problem that includes, given an input, finding what should be minimally and sufficiently present (i.e., important object pixels in an image) to justify its classification and analogously what should be minimally and necessarily absent (i.e., certain background pixels). What is minimally but critically absent is an important part of an explanation, which has not been identified by current explanation methods that explain predictions of neural networks.

In an exemplary embodiment, the present invention can provide a computer-implemented method for contrastive explanations for interpreting a deep neural network, the contrastive explanation method including highlighting a minimally sufficient component in an input to justify a classification, identifying contrastive characteristics or features that are minimally and critically absent, maintaining the classification and distinguishing it from a second input that is closest to the classification but is identified as a second classification.

One or more other exemplary embodiments include a computer program product and a system.

Other details and embodiments of the invention will be described below, so that the present contribution to the art can be better appreciated. Nonetheless, the-invention is not limited in its application to such details, phraseology, terminology; illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a contrastive explanations method (GEM) 100;

FIG. 2 exemplarily depicts an original prediction, a CEM PP, and a CEM PN according to an embodiment of the present invention;

FIG. 3 exemplarily depicts a CEM PP for the contrastive explanation method 100 according to an embodiment of the present invention;

FIG. 4 exemplarily depicts a CEM PN for the contrastive explanation method 100 according to an embodiment of the present invention;

FIG. 5 exemplarily depicts a first algorithm according to an embodiment of the present invention;

FIG. 6 exemplarily depicts results using handwritten digits that are classified using a feed-forward convolutional neural network (CNN) trained on 60,000 training images according an embodiment of the present invention and using conventional techniques;

FIG. 7 exemplarily depicts results of the CEM according to an embodiment of the present invention contrasted with results of conventional techniques;

FIG. 8 exemplarily shows example invoices (IDs anonymized), one at low risk, one at medium and one at high risk level to evaluate the CEM according to an embodiment of the present invention contrasted with results of conventional techniques;

FIG. 9 depicts a cloud computing node 10 according to an embodiment of the present invention;

FIG. 10 depicts a cloud computing environment 50 according to an embodiment of the present invention; and

FIG. 11 depicts abstraction model layers according to an embodiment of the present invention.

### DETAILED DESCRIPTION

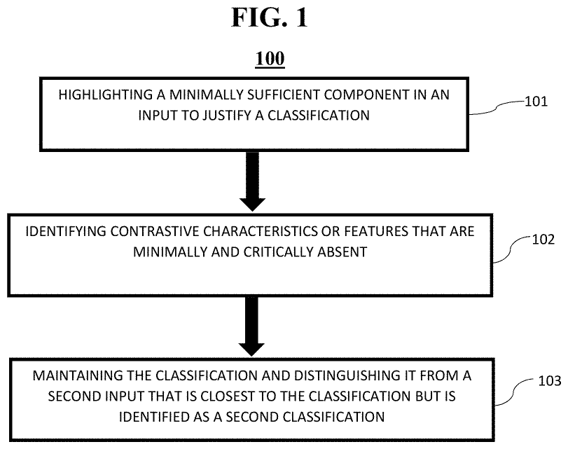

The invention will now be described with reference to FIG. 1-11, in which like reference numerals refer to like parts throughout. It is emphasized that, according to common practice, the various features of the drawing are not necessarily to scale. On the contrary, the dimensions of the various features can be arbitrarily expanded or reduced for clarity.

With reference now to the example depicted in FIG. 1, the contrastive explanation method 100 includes various steps that, given an input and its classification by a neural network, CEM creates explanations for the input by finding a minimal amount of (i.e., object/non-background) features in the input that are sufficient in themselves to yield the same classification (i.e. PPs), finding a minimal amount of features that should be absent (i.e., remain background) in the input to prevent the classification result from changing (i.e., PNs), and finding PNs and PPs “dose” to the data manifold so as to obtain more “realistic” explanations.

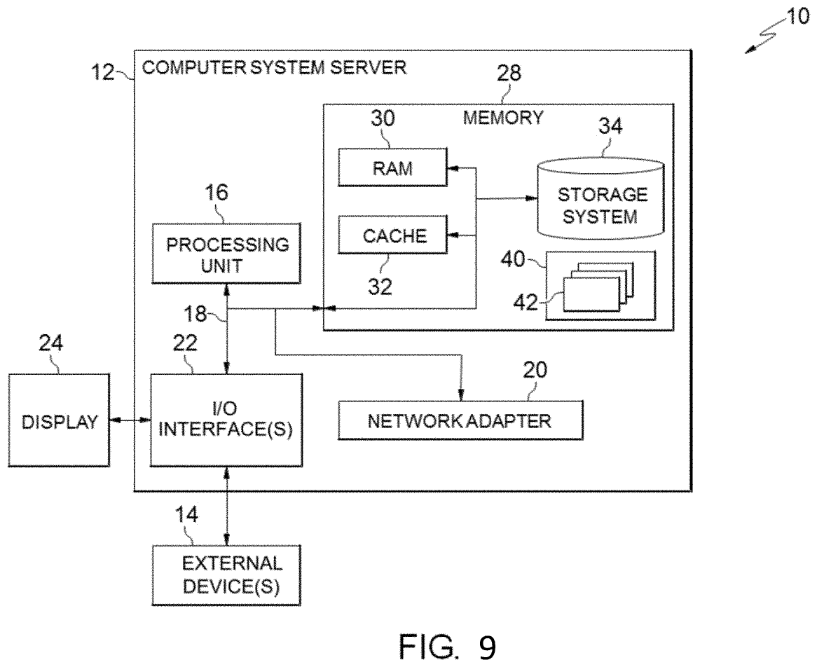

As shown in at least FIG. 9, one or more computers of a computer system 12 according to an embodiment of the present invention can include a memory 28 having instructions stored in a storage system to perform the steps of FIG. 1.

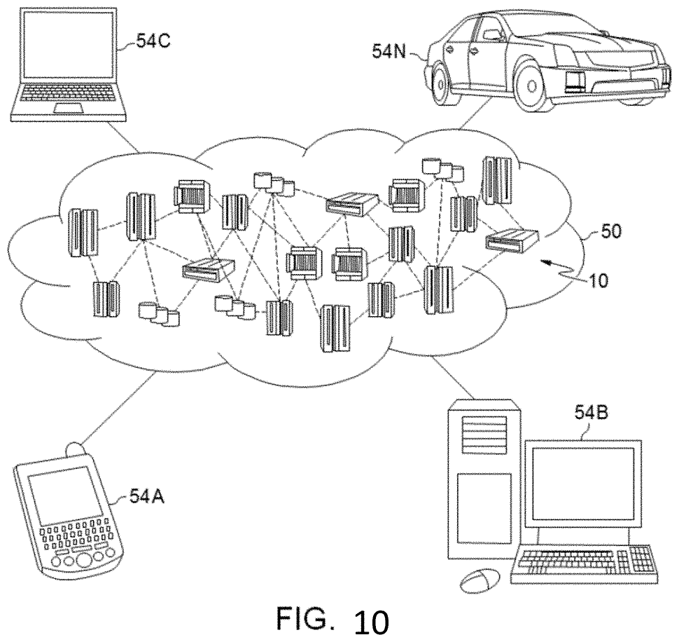

Although one or more embodiments (see e.g., FIGS. 9-11) may be implemented in a cloud environment 50 (see e.g., FIG. 10), it is nonetheless understood that the present invention can be implemented outside of the cloud environment.

With reference generally to FIGS. 1-8, explanations are generated for neural networks, in which, besides highlighting what is minimally sufficient (e.g., tall and long hair) in an input to justify its classification (e.g., step 101), contrastive characteristics or features are identified that should be minimally and critically absent (e.g. glasses) (i.e., step 102), so as to maintain the current classification and to distinguish it from another input that is “closest” to it but would be classified differently (e.g., Bob) (i.e., step 103), For purposes of the invention, minimally sufficient is determined by a minimum number of attributes to classify the input as a first class. Further, ‘closest’ is determined by what the input is classified as being nearest to a value.

That is, the invention generates explanations of the form, for example, “An input x is classified in class y because features fᵢ, . . . , fₖ are present and because features fₘ, . . . , fₚ are absent.”

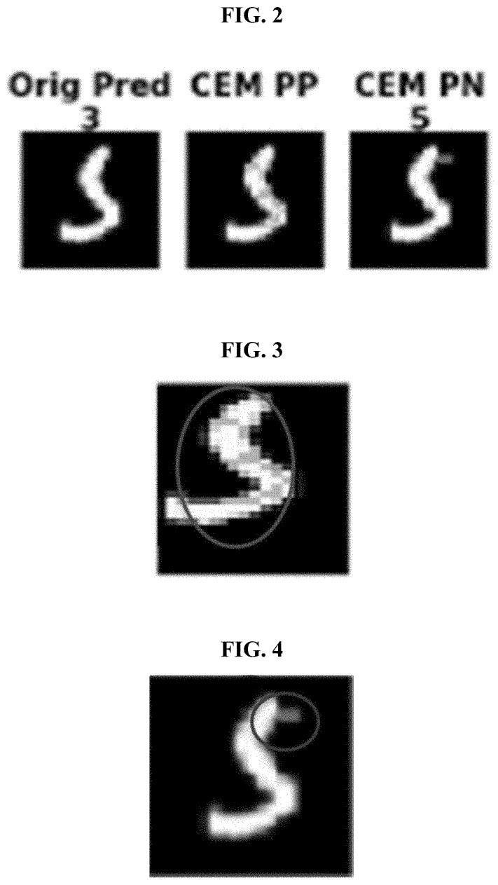

It may seem that such crisp explanations are only possible for binary data. However, they are also applicable to continuous data with no explicit discretization or binarization required. For example, in FIG. 2, hand-written digits are shown from a dataset, the black background represents no signal or absence of those specific features, which in this ease are pixels with a value of zero. Any non-zero value then would indicate the presence of those features/pixels. This idea also applies to colored images where the most prominent pixel value (say median/mode of all pixel values) can be considered as no signal and moving away from this value can be considered as adding signal. One may also argue that there is some information loss in the form of explanation. However, such explanations are lucid and easily understandable by humans who can always further delve into the details of the generated explanations such as the precise feature values, which are readily available.

In fact, there is another strong motivation to have such form of explanations due to their presence in certain human-critical domains. A pertinent positive (PP) is a factor whose presence is minimally sufficient in justifying the final classification. On the other hand, a pertinent negative (PN) is a factor whose absence is necessary in asserting the final classification. For example in medicine, a patient showing symptoms of cough, cold and fever, but no sputum or chills, will most likely be diagnosed as having flu rather than having pneumonia. Cough, cold and fever could imply both flu or pneumonia. However, the absence of sputum and chills leads to the diagnosis of flu. Thus, sputum and chills are pertinent negatives, which along with the pertinent positives are critical and in some sense sufficient for an accurate diagnosis.

To achieve such, an explanation method (i.e., a contrastive explanations method (CEM) 100 for neural networks) can highlight not only the pertinent positives but also the pertinent negatives (i.e., step 101). This is seen in FIG. 2 where the explanation of the image being predicted as a ‘3’ does not only highlight the important pixels (which look like a ‘3’) that should be present for it to be classified as a ‘3’, but also highlights a small horizontal line (the pertinent negative CEM PN) at the top whose presence would change the classification of the image to a ‘5’ and thus should be absent for the classification to remain a ‘3’. Therefore, the explanation for the digit in FIG. 2 is that the digit is a ‘3’ because the cyan pixels (shown in column 2) are present and the pink pixels (shown in column 3) are absent. This second part is critical for an accurate classification and is not highlighted by any of the other state-of-the-art interpretability methods.

Moreover, given the original image, the pertinent positives highlight what should be present that is necessary and sufficient (e.g., as shown in FIG. 3). And, as shown in FIG. 4, the pertinent negatives highlight what should not be present, for the example to be classified as a ‘3’.

It is noted that the conceptual distinction between pertinent negatives that are identified and negatively correlated or relevant features that other methods highlight. The question that is being answered via the method 100 is: “why is input x classified in class y?”.

Ergo, any human asking this question wants all the evidence in support of the hypothesis of x being classified as class y. The inventive pertinent positives as well as pertinent negatives are evidences in support of this hypothesis. However, unlike the positively relevant features highlighted by other methods that are also evidence supporting this hypothesis, the negatively relevant features by definition do not. Hence, another motivation for the work is that when a human asks the above question, they are more interested in evidence supporting the hypothesis rather than information that devalues it. This latter information is definitely interesting, but is of secondary importance when it comes to understanding the human's intent behind the question.

Thereby, the method 100, in step 101, highlights a minimally sufficient component in an input to justify a classification. In step 102, contrastive characteristics or features are identified that are minimally and critically absent. And, in step 103, the classification is maintained and distinguished from a second input that is closest to the classification but is identified as a second classification.

In other words, the method 100 finds a minimal amount of (i.e., object/non-background) features in the input that are sufficient in themselves to yield the same classification (i.e., PPs), finds a minimal amount of features that should be absent (i.e., remain background) in the input to prevent the classification result from changing (i.e., PNs), and does both these steps as “close” to the data manifold so as to obtain more “realistic” explanations.

With reference to FIG, 5, which is a basis of the method 100, let X denote the feasible data space and let (x₀, t₀) denote an example x0∈X and its inferred class label t₀ obtained from a neural network model. The modified example x∈X based on x₀ is defined as x=x₀+δ, where ‘δ’ is a perturbation applied to x₀. The method of finding pertinent positives/negatives is formulated as an optimization problem over the perturbation variable ‘δ’ that is used to explain the model's prediction results. One denotes the prediction of the model on the example x by Pred(x), where Pred(·) is any function that outputs a vector of prediction scores for all classes, such as prediction probabilities and logits (un-normalized probabilities) that are widely used in neural networks, among others.

To ensure the modified example ‘x’ is still close to the data manifold of natural examples, an auto-encoder may be used to evaluate the closeness of x to the data manifold. This is denoted by AE(x) the reconstructed example of x using the auto-encoder AE(·).

For pertinent negative analysis (i.e., step 102), one is interested in what is missing in the model prediction. For any natural example x₀, the notation X/x₀ is used to denote the space of missing parts with respect to x₀. One aims to find an interpretable perturbation δ∈X/x₀ to study the difference between the most probable class predictions in arg maxᵢ [Pred(x₀)]ᵢ and arg maxᵢ [Pred(x₀+δ)]ᵢ. Given (x₀, t₀), the method finds a pertinent negative by solving the following optimization problem:

$${min}_{δ ∈ χ / {x}_{0}} c \cdot {f}_{κ}^{neg} ( {x}_{0} , δ ) + β {‖ δ ‖}_{1} + {‖ δ ‖}_{2}^{2} + γ {‖ {x}_{0} + δ - AE ( {x}_{0} + δ ) ‖}_{2}^{2} . \qquad ( 1 )$$

The role of each term is elaborated in the objective function (1) as follows. The first term f_{κ}^{neg}(x₀,δ) is a designed loss function that encourages the modified example x=x⁰+δ to be predicted as a different class than t₀=arg maxᵢ [Pred(x₀)]ᵢ. The loss function is defined as:

$${f}_{κ}^{neg} ( {x}_{0} , δ ) = max \{ {[ Pred ( {x}_{0} + δ ) ]}_{{t}_{0}} - {max}_{i \neq {t}_{0}} {[ Pred ( {x}_{0} + δ ) ]}_{i} , - κ \} \qquad ( 2 )$$

where [Pred(x₀+δ)]ᵢ is the i-th class prediction score of x₀+δ. The hinge-like loss function favors the modified example x to have a top-1 prediction class different from that of the original example x₀. The parameter κ≥0 is a confidence parameter that controls the separation between [Pred(x₀+δ)]t₀ and max_{i≠t}_{₀} [Pred(x₀+δ)]ᵢ. The second and the third terms β∥\hat{δ}∥₁+∥δ∥₂² in equation (1) are jointly called the elastic net regularizer, which is used for efficient feature selection in high-dimensional learning problems. The last term ∥x₀+δ−AE(x₀+δ)∥₂² is an L₂ reconstruction error of x evaluated b the auto-encoder. This is relevant provided that a well-trained auto-encoder for the domain is obtainable. The parameters c, β, γ, ≥0 are the associated regularization coefficients.

For the pertinent positive analysis (i.e., step 101), one is interested in the critical features that are readily present in the input. Given a natural example x₀, the space of its existing components is denoted by X∩x₀. Here, it is the aim at finding an interpretable perturbation δ ∈X∩x₀ such that after removing it from x₀, arg maxᵢ[Pred(x₀)]ᵢ=arg maxᵢ[Pred(δ)]ᵢ. That is, x₀ and δ will have the same top-1 prediction class t₀, indicating that the removed perturbation δ is representative of the model prediction on x0. Similar to finding pertinent negatives, the findings are formulated as pertinent positives as the following optimization problem:

$${min}_{δ ∈ χ ⋂ {x}_{0}} c \cdot {f}_{κ}^{pos} ( {x}_{0} , δ ) + β {‖ δ ‖}_{1} + {‖ δ ‖}_{2}^{2} + γ {‖ {x}_{0} + δ - AE ( δ ) ‖}_{2}^{2} . \qquad ( 3 )$$

where the loss function f_{κ}^{pos}(x₀, δ) is defined as:

$${f}_{κ}^{pos} ( {x}_{0} , δ ) = max \{ {max}_{i \neq {t}_{0}} {[ Pred ( δ ) ]}_{i} - {[ Pred ( δ ) ]}_{{t}_{0}} , - κ \} . \qquad ( 4 )$$

In other words, for any given confidence κ≥0, the loss function f_{κ}^{pos} is minimized when [Pred(δ)]t₀ is greater than max_{i≠t}_{₀}[Pred(δ)]ᵢ by at least κ.

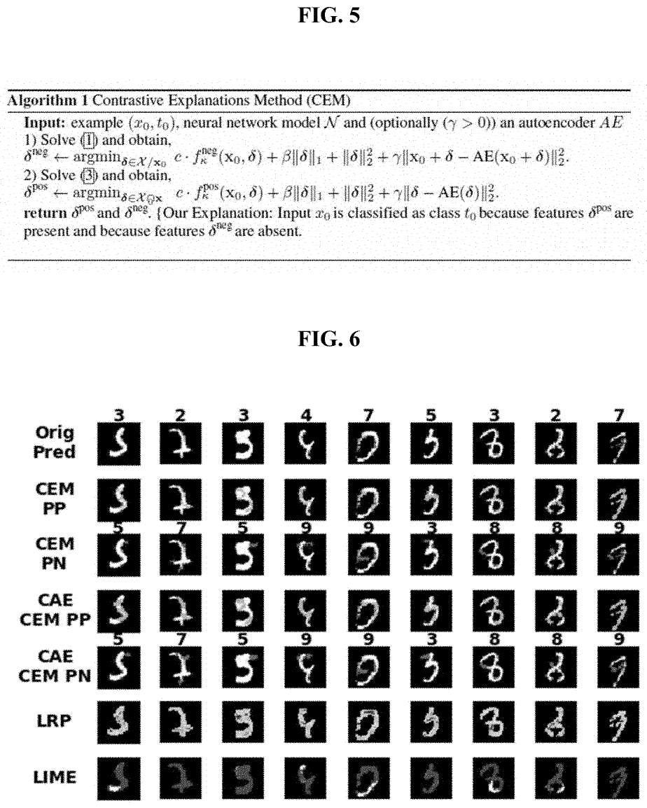

As shown in FIG. 5, equation (1) and (3) are solved to give δ^{pos} and δ^{neg} as the pertinent positives and pertinent negatives. To do so, a projected fast iterative shrinkage-thresholding algorithm (FISTA) is applied to solve problems (1) and (3). FISTA is an efficient solver for optimization problems involving L₁ regularization, Take pertinent negative as an example, assume X=[1−1, l]^{p}, X/x₀=[0, 1]^{p} and let:

g(δ)=f_{κ}^{neg}( [symbol] ₀,δ)+∥δδ₂^{2̅}+γ∥x₀+δ− [symbol] (x₀+δ)∥₂² denote the

objective function of (1) without the L₁ regularization term. Given the initial iterate δ(0)=0, projected FISTA iteratively updates the perturbation I times by

$$\begin{matrix}{δ}^{( k + 1 )} = {Π}_{{[ 0 , 1 ]}^{p}} \{ {S}_{β} ( {y}^{( k )} - {α}_{k} ∇ g ( {y}^{( k )} ) ) \} ; & ( 5 ) \\ {y}^{( k + 1 )} = {Π}_{{[ 0 , 1 ]}^{p}} \{ {δ}^{( k + 1 )} + \frac{k}{k + 3} ( {δ}^{( k + 1 )} - {δ}^{( k )} ) \} , & ( 6 )\end{matrix}$$

where Π_{[0,1]p} denotes the vector projection onto the set X/x₀=[0, 1]ₚ, αₖ is the step size, y(k) is a slack variable accounting for momentum acceleration with y(0)=δ(0), and S_{β}: [symbol] ^{p} [symbol] [symbol] ^{p} is an element-wise shrinage-thresholding function defined as:

$${[ {S}_{β} ( z ) ]}_{i} = \{ \begin{matrix}{z}_{i} - β , & if {z}_{i} > β ; \\ 0 , & if \vert {z}_{i} \vert \leq β ; \\ {z}_{i} + β , & if {z}_{i} < - β ,\end{matrix} \qquad ( 7 )$$

where for any i∈{1, . . . , p}. The final perturbation δ^{(k*}) for pertinent negative analysis is selected from the set {δ^{(k)}}ₖ₌₁^{I} such that f_{κ}^{neg}(x₀, δ^{(k*)})=0 and k*=arg min_{κ∈{}1, . . . , I)}β∥δ∥₁+∥δ∥₂². A similar approach is applied for the pertinent positive.

Eventually, as seen in Algorithm 1 of FIG. 5, both the pertinent negative δ^{neg} and the pertinent positive δ^{pos} are obtained from the optimization methods to explain the model prediction. The last term in both (1) and (3) will be included only when an accurate auto-encoder is available, else γ is set to zero.

Thereby, it has been shown how the method 100 can be effectively used to meaningful explanations in different domains that are presumably easier to consume as well as more accurate. It's interesting that pertinent negatives play an essential role in many domains, where explanations are important. As such, it seems though that they are most useful when inputs in different classes are “close” to each other. For instance, they are more important when distinguishing a diagnosis of flu or pneumonia, rather than say a microwave from an airplane. If the inputs are extremely different then probably pertinent positives are sufficient to characterize the input, as there are likely to be many pertinent negatives, which will presumably overwhelm the user.

As such, the inventors submit that the explanation method CEM 100 can be useful for other applications where the end goal may not be to just obtain explanations. For instance, one could use it to choose between models that have the same test accuracy. A model with possibly better explanations may be more robust. One could also use the method 100 for model debugging, (i.e., finding biases in the model in terms of the type of errors it makes or even in extreme case for model improvement).

Accordingly, the descriptions herein have provided a novel explanation method, which finds not only what should be minimally present in the input to justify its classification by black box classifiers such as neural networks, but also finds contrastive perturbations, in particular, additions, that should be necessarily absent to justify the classification. The method 100 is validated below in ‘Experimental Results’ section which shows the efficacy of the approach on multiple datasets from different domains, and shown the power of such explanations in terms of matching human intuition, thus making for more complete and well-rounded explanations.

### Experimental Results

Results are first shown in FIG. 6 based on the handwritten digits Modified National Institute of Standards and Technology (MNIST) dataset. In this case, examples of explanations for the method are provided with and without an auto-encoder.

To setup the experiment, the handwritten digits are classified using a feed-forward convolutional neural network (CNN) trained on 60,000 training images from the MNIST benchmark dataset. The CNN has two sets of convolution-convolution-pooling layers, followed by three fully-connected layers. Further details about the CNN whose test accuracy was 99.4% and a detailed description of the CAE which consists of an encoder and a decoder component are given in the supplement.

The CEM method 100 is applied to MNIST with a variety of examples illustrated in FIG. 6. Results using a convolutional auto-encoder (CAE) to learn the pertinent positives and negatives are displayed. While results without a CAE are quite convincing, the CAE clearly improves the pertinent positives and negatives in many cases. Regarding pertinent positives, the cyan highlighted pixels in the column with CAE (CAE CEM PP) are a superset to the cyan-highlighted pixels in a column without (CEM PP). While these explanations are at the same level of confidence regarding the classifier, explanations using an auto-encoder (AE) are visually more interpretable. Take for instance the digit classified as a ‘2’ in column 2. A small part of the tail of a ‘2’ is used to explain the classifier without a CAE, while the explanation using a CAE has a much thicker tail and larger part of the vertical curve. In row 3, the explanation of the ‘3’ is quite clear, but the CAE highlights the same explanation but much thicker with more pixels. The same pattern holds for pertinent negatives. The horizontal line in column 4 that makes a ‘4’ into a ‘9’ is much more pronounced when using a CAE. The change of a predicted ‘7’ into a ‘9’ in column ‘5’ using a CAE is much more pronounced.

The two state-of-the-art methods exemplarily used for explaining the classifier in FIG. 6 are LRP and LIME. LRP has a visually appealing explanation at the pixel level. Most pixels are deemed irrelevant (green) to the classification (note the black background of LRP results was actually neutral). Positively relevant pixels (yellow/red) are mostly consistent with the pertinent positives using the method 100, though the pertinent positives do highlight more pixels for easier visualization. The most obvious such examples are column 3 where the yellow in LRP outlines a similar 3 to the pertinent positive and column 6 where the yellow outlines most of what the pertinent positive provably deems necessary for the given prediction. There is little negative relevance in these examples, though two interesting cases are pointed out. In column 4, LRP shows that the little curve extending the upper left of the 4 slightly to the right has negative relevance (also shown by CEM as not being positively pertinent). Similarly, in column 3, the blue pixels in LRP are a part of the image that must obviously be deleted to see a clear 3. LIME is also visually appealing However, the results are based on superpixels—the images were first segmented and relevant segments were discovered. This explains why most of the pixels forming the digits are found relevant. While both methods give important intuitions, neither illustrate what is necessary and sufficient about the classifier results as does the contrastive explanations method 100.

In a second experiment, the method 100 is evaluated on a real procurement dataset obtained from a large corporation. This nicely complements the other experiments on image datasets.

To setup the experiment, the data spans a one-year period and consists of millions of invoices submitted by over tens of thousands vendors across 150 countries. The invoices were labeled as being either ‘low risk’, ‘medium risk’, or ‘high risk’ based on a large team that approves these invoices. To make such an assessment, besides just the invoice data, access to multiple public and private data sources were given such as a vendor master file (VMF), a risky vendors list (RVL), a risky commodity list (RCL), a financial index (FI), a forbidden parties list (FPL), a country perceptions index (CPI), a tax havens list (THL) and a Dun & Bradstreet numbers (DUNS). Based on the above data sources, there are tens of features and events whose occurrence hints at the riskiness of an invoice.

For example, the experiment looked for: 1) if the spend with a particular vendor is significantly higher than with other vendors in the same country, 2) if a vendor is registered with a large corporation and thus its name appears in a VMF, 3) if a vendor belongs to RVL, 4) if the commodity on the invoice be-longs to RCL, 5) if the maturity based on FI is low, 6) if vendor belongs to FPL, 7) if a vendor is in a high risk country (i.e. CPI<25), 8) if a vendor or its bank account is located in. a tax haven, 9) if a vendor has a DUNs number, 10) if a vendor and the employee bank account numbers match, and 11) if a vendor only possesses a PO box with no street address.

With these data, a three-layer neural network was trained with fully connected layers, 512 rectified linear units and a three-way softmax function. The 10-fold cross validation accuracy of the network was high (91.6%).

15 invoices were randomly chosen that were classified as low risk, 15 classified as medium risk and 15 classified as high risk, Feedback was requested on these 45 invoices in terms of whether or not the pertinent positives and pertinent negatives highlighted by each of the methods was suitable to produce the classification. To evaluate each method, the percentage of invoices is computed with explanations agreed by the experts based on this feedback.

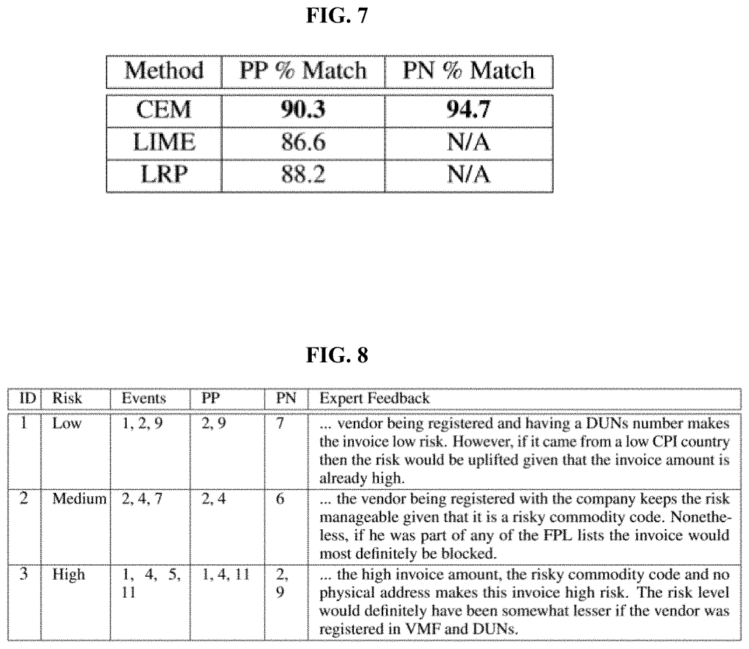

In FIG. 7, the percentage of times the pertinent positives matched with the experts judgment can be seen for the different methods as well as additionally the pertinent negatives for ours. In both cases, it is noted that the explanations of the invention closely match human judgment. Of course, proxies are used for the competing methods as neither of them. identify PPs or PNs. There were no really good proxies for PNs as negatively relevant features are conceptually quite different as discussed in the supplement.

FIG. 8 shows three example invoices, one belonging to each class and the explanations produced by our method along with the expert feedback. It is seen that the expert feedback validates our explanations and showcases the power of pertinent negatives in making the explanations more complete as well as intuitive to reason with. An interesting aspect here is that the medium risk invoice could have been perturbed towards low risk or high risk.

However, the method 100 found that it is closer (minimum perturbation) to being high risk and thus suggested a pertinent negative that takes it into that class. Such informed decisions can be made by the method 100 as it searches for the most “crisp” explanation, arguably similar to those of humans.

That is, at a high level, the invention may identify important indicators that would justify a decision as well as identify (a minimal set of) indicators which if present would have changed the decision.

### Exemplary Aspects, Using a Cloud Computing Environment

Although this detailed description includes an exemplary embodiment of the present invention in a cloud computing environment, it is to be understood that implementation of the teachings recited herein arc not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several. organizations and supports a specific community that has shared concerns (e.g., mission, security requirements, policy; and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

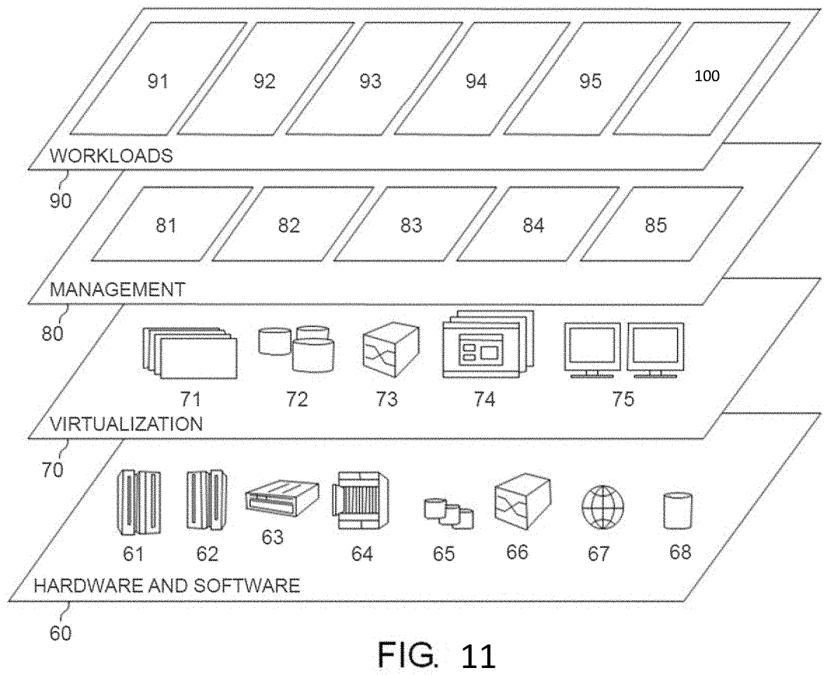

Referring now to FIG. 11, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 11, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA.) bus, Enhanced ISA (EISA) bus, Video Electronics Standards Association (VESA) local bus, and Peripheral Component interconnects (PCI) bus.

Computer system/server 12 typically includes a variety of computer system readable media. Such media may be any available media that. is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only; storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical. disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 12, illustrative cloud computing environment 50 is depicted. As shown, cloud computing environment 50 comprises one or re cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 12 are intended to be illustrative only and that computing nodes 10 and cloud computing environment 50 can communicate with any type of computerized circuit over any type of network and/or network addressable connection (e.g., using a web browser).

Referring now to FIG. 13, an exemplary set of functional abstraction layers provided by cloud computing environment 50 (FIG. 12) is shown. It should be understood in advance that the components, layers, and functions shown in FIG. 13 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators, Service level management 84 provides cloud computing resource allocation and management such that required service levels are met, Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized, Examples of workloads and functions which may be provided from this layer include: mapping and navigation 91; software development and lifecycle management 92; virtual classroom education delivery 93; data analytics processing 94; transaction processing 95; and, more particularly relative to the present invention, the method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable loge arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular m such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented method for contrastive explanations for interpreting a deep neural network, the contrastive explanation method comprising:
highlighting a minimally sufficient component in an input to justify a classification;
identifying contrastive characteristics or features of the input that are minimally and critically absent; and
maintaining the classification and distinguishing the classification from a second input that is closest to the classification but is identified as a second classification.

2. The computer-implemented method of claim 1, further comprising:
finding a sufficient minimal amount of features in an input that are sufficient in themselves to yield a same classification;
finding an absent minimal amount of features that should be absent in the input to prevent a classification result from changing; and
providing an explanation of the input based on the sufficient minimal amount of features and the absent minimal amount of features.

3. The computer-implemented method of claim 1, wherein the identifying identifies pertinent negatives as the contrastive characteristics or features that are minimally and critically absent from the input, and
wherein the highlighting highlights pertinent positives as the minimally sufficient component in the input to justify the classification.

4. The computer-implemented method of claim 3, wherein the pertinent negative is found by solving the following optimization problem:
$${min}_{δ ∈ χ / {x}_{0}} c \cdot {f}_{κ}^{neg} ( {x}_{0} , δ ) + β {‖ δ ‖}_{1} + {‖ δ ‖}_{2}^{2} + γ {‖ {x}_{0} + δ - AE ( {x}_{0} + δ ) ‖}_{2}^{2} ,$$
where:
f_{κ}^{neg}(x₀, δ) is a designed loss function that encourages he modified example x=x₀+δ to be predicted as a different class than t₀=arg maxᵢ[Pred(x₀)]ᵢ,
the loss function is defined as:
$${f}_{κ}^{neg} ( {x}_{0} , δ ) = max \{ {[ Pred ( {x}_{0} + δ ) ]}_{{t}_{0}} - {max}_{i \neq {t}_{0}} {[ Pred ( {x}_{0} + δ ) ]}_{i} , - κ \}$$
[Pred(x₀αδ)]ᵢ is the i-th class prediction score of x₀+δ,
the parameter κ≥0 is a confidence parameter that controls the separation between [Pred(x₀+δ)]t₀ and Imax_{i≠t}_{₀}[Pred(x₀+δ)]ᵢ,
β∥ [symbol] ∥1+∥δ∥₂² are jointly called the elastic net regularize; which is used for efficient feature selection in high-dimensional learning problems,
∥x₀+δ−AE(x₀+δ)∥₂² is an L₂ reconstruction error of x evaluated by an auto-encoder, and
the parameters c, β, γ, ≥0 are associated regularization coefficients.

5. The computer-implemented method of claim 3, wherein the pertinent negative is found by solving an optimization problem for an interpretable perturbation to determine a difference between most probable class predictions.

6. The computer-implemented method of claim 2, wherein the sufficient minimal amount of features and the absent minimal amount of features are enhanced via an auto-encoder.

7. The computer-implemented method of claim 2, wherein the finding the sufficient minimal amount of features and the finding the absent minimal amount of features use a projected fast iterative shrinkage-thresholding algorithm to solve for each, respectively.

8. The computer-implemented method of claim 3, wherein the pertinent positive is found by solving the following optimization problem:
$${min}_{δ ∈ χ ⋂ {x}_{0}} c \cdot {f}_{κ}^{pos} ( {x}_{0} , δ ) + β {‖ δ ‖}_{1} + {‖ δ ‖}_{2}^{2} + γ {‖ δ - AE ( δ ) ‖}_{2}^{2} , ,$$
where:
f_{κ}^{pos}(x_{0,} δ) is a designed loss function that encourages the modified example x=x₀+δ to be predicted as a different class than t₀=arg maxi [Pred(x₀)]ᵢ,
the loss function is defined as:
$${f}_{κ}^{pos} ( {x}_{0} , δ ) = max \{ {max}_{i \neq {t}_{0}} {[ Pred ( δ ) ]}_{i} - {[ Pred ( δ ) ]}_{{t}_{0}} , - κ \} ,$$
where the loss function f_{κ}^{pos} is minimized when [Pred(δ)]t₀ is greater than max_{i≠t}_{₀}[Pred(δ)]ᵢ by at least κ.

9. The computer-implemented method of claim 1, wherein the minimally sufficient component comprises a pertinent positive indicating a feature present in a correct classification of the classification, and
wherein the contrastive characteristics or features comprise a pertinent negative indicating a feature absent from the correct classification of the classification.

10. The computer-implemented method of claim 1, wherein the highlighting identifies a feature present in a correct classification of the classification, and
wherein identifying identifies a feature that is not intended to be in the input of the correct classification of the classification.

11. The computer-implemented method of claim 1, embodied in a cloud-computing environment.

12. A computer program product for contrastive explanations for interpreting a deep neural network, the computer program product comprising a computer-readable storage medium having program instructions embodied therewith, the program instructions executable by a computer to cause the computer to perform:
highlighting a minimally sufficient component in an input to justify a classification;
identifying contrastive characteristics or features of the input that are minimally and critically absent; and
maintaining the classification and distinguishing the classification from a second input that is closest to the classification but is identified as a second classification.

13. The computer program product of claim 12, further comprising:
finding a sufficient minimal amount of features in an input that are sufficient in themselves to yield a same classification;
finding an absent minimal amount of features that should be absent in the input o prevent a classification result from changing; and
providing an explanation of the input based on the sufficient minimal amount of features and the absent minimal amount of features.

14. The computer program product of claim 12,
wherein the identifying identifies pertinent negatives as the contrastive characteristics or features that are minimally and critically absent from the input, and
wherein the highlighting highlights pertinent positives as the minimally sufficient component in the input to justify the classification.

15. The computer program product of claim 14, wherein the pertinent negative is found by solving the following optimization problem:
$${min}_{δ ∈ χ / {x}_{0}} c \cdot {f}_{κ}^{neg} ( {x}_{0} , δ ) + β {‖ δ ‖}_{1} + {‖ δ ‖}_{2}^{2} + γ {‖ {x}_{0} + δ - AE ( {x}_{0} + δ ) ‖}_{2}^{2} ,$$
where:
f_{κ}^{neg}(x₀, δ)is a designed loss function that encourages the modified example x=x₀+δ to be predicted as a different class than t₀=arg maxᵢ [Pred(x₀)]ᵢ,
the loss function is defined as:
$${f}_{κ}^{neg} ( {x}_{0} , δ ) = max \{ {[ Pred ( {x}_{0} + δ ) ]}_{{t}_{0}} - {max}_{i \neq {t}_{0}} {[ Pred ( {x}_{0} + δ ) ]}_{i} , - κ \}$$
[Pred(x₀+δ)]ᵢ is the i-th class prediction score of x₀+δ,
the parameter κK≥0 is a confidence parameter that controls the separation between [Pred(x₀+δ]t₀ and max_{i≠t}_{₀}[Pred(x₀+δ)]ᵢ,
β∥\hat{δ} ∥₁+∥δ∥₂² are jointly called the elastic net regularizer, which is used for efficient feature selection in high-dimensional learning problems,
∥x₀+δ−AE(x₀+δ)∥₂² is an L₂ reconstruction error of x evaluated by an auto-encoder, and
the parameters c, β, γ, ≥0 are associated regularization coefficients.

16. The computer program product of claim 14, wherein the pertinent negative is found by solving an optimization problem for an interpretable perturbation to determine a difference between most probable class predictions.

17. The computer program product of claim 13, wherein the sufficient minimal amount of features and the absent minimal amount of features are enhanced via an auto-encoder.

18. The computer program product of claim 13, wherein the finding the sufficient minimal amount of features and the finding the absent minimal amount of features use a projected fast iterative shrinkage-thresholding algorithm to solve for each, respectively.

19. The computer program product of claim 14, wherein the pertinent positive is found by solving the following optimization problem:
$${min}_{δ ∈ χ ⋂ {x}_{0}} c \cdot {f}_{κ}^{pos} ( {x}_{0} , δ ) + β {‖ δ ‖}_{1} + {‖ δ ‖}_{2}^{2} + γ {‖ δ - AE ( δ ) ‖}_{2}^{2} , ,$$
where:
f_{κ}^{pos}(x₀, δ) is a designed loss function that encourages the modified example x=x₀+δ to be predicted as a different class than t₀=arg maxᵢ [Pred(x₀)]ᵢ,
the loss function is defined as:
$${f}_{κ}^{pos} ( {x}_{0} , δ ) = max \{ {max}_{i \neq {t}_{0}} {[ Pred ( δ ) ]}_{i} - {[ Pred ( δ ) ]}_{{t}_{0}} , - κ \} ,$$
where the loss function f_{κ}^{pos} is minimized when [Pred(δ)]t₀ is greater than max_{i≠t}_{₀}[Pred(δ)]ᵢ by at least κ.

20. The computer program product of claim 12, wherein the minimally sufficient component comprises a pertinent positive indicating a feature present in a correct classification of the classification, and
wherein the contrastive characteristics or features comprise a pertinent negative indicating a feature absent from the correct classification of the classification.

21. The computer program product of claim 12, wherein the highlighting identifies a feature present in a correct classification of the classification, and
wherein identifying identifies a feature that is not intended to be in the input of the correct classification of the classification.

22. A system for contrastive explanations for interpreting a deep neural network, said system comprising:
a processor; and
a memory, the memory storing instructions to cause the processor to perform:
highlighting a minimally sufficient component in an input to justify a classification;
identifying contrastive characteristics or features of the input that are minimally and critically absent; and
maintaining the classification and distinguishing the classification from a second input that is closest to the classification but is identified as a second classification.

23. The system of claim 22, embodied in a cloud-computing environment.

24. A computer-implemented method for contrastive explanations for interpreting a deep neural network, the contrastive explanation method comprising:
finding a sufficient minimal amount of features in an input that are sufficient in themselves to yield a same classification;
finding ala. absent minimal amount of features that should be absent in the input to prevent a classification result from changing; and
providing an explanation of the input based on the sufficient minimal amount of features and the absent minimal amount of features.

25. A computer-implemented method for contrastive explanations for interpreting a deep neural network, the contrastive explanation method comprising:
finding a sufficient minimal amount of features in an input that are sufficient in themselves to yield a first classification; and
finding an absent minimal amount of features that should be absent in the input to prevent a classification result from changing from the first classification to a second classification.
